(19) United States
(12) Patent Application Publication
(10) Pub. No.: US 2026/0038284 A1
(43) Pub. Date: Feb. 5, 2026

(54) DETECTION OF ACID-FAST BACTERIA USING OBJECT DETECTION PIPELINES

(71) Applicant: University of Utah Research Foundation, Salt Lake City, UT (US)

(72) Inventors: Paul English, Salt Lake City, UT (US); David P. Ng, Salt Lake City, UT (US); Blaine A. Mathison, Salt Lake City, UT (US); Jeffrey Ryan Gilivary, Salt Lake City, UT (US); Amanda Melodee Vance, Salt Lake City, UT (US); Robert Ohgami, Salt Lake City, UT (US); Brendan Daniel O'Fallon, Salt Lake City, UT (US); Salika Mehreen Shakir, Salt Lake City, UT (US); Leo Lin, Salt Lake City, UT (US); Alok Anil Jadhav, Salt Lake City, UT (US)

(21) Appl. No.: 19/288,804

(22) Filed: Aug. 1, 2025

Related U.S. Application Data
(60) Provisional application No. 63/679,034, filed on Aug. 2, 2024.

(51) Int. Cl. G06V 20/69; G01N 1/30; G06V 10/82

(52) U.S. Cl. CPC G06V 20/69; G01N 1/30; G06V 10/82; G01N 2001/302

(57) ABSTRACT

Disclosed herein is a detection system configured to assess the density of acid-fast bacteria (AFB) in a sputum smear that has been stained with a non-fluorescent staining technique. The computer system assesses the density of AFB in a sputum smear using one or more object detection models, wherein the object detection models are configured to identify AFB stained using a non-fluorescent staining process. The disclosed system can increase throughput and accuracy of AFB density assessment in a diagnostic laboratory setting and can improve throughput and accuracy of more cost-effective methods of assessing AFB density such as a Kinyoun staining process.

### CROSS REFERENCE TO RELATED APPLICATIONS

This application claims priority to and the benefit of U.S. Provisional Application No. 63/679,034, filed Aug. 2, 2024, the entirety of which is incorporated herein by reference.

### BACKGROUND

Acid-fast bacteria (AFB) are a class of bacteria whose infection may cause severe disease such as tuberculosis, leprosy, and others. As a result, AFB infection is commonly screened in diagnostic laboratories. Because these bacteria possess acid-fastness, or the ability to hold onto stain in the presence of acid, they can be observed under a microscope after staining. Currently, AFB are commonly stained using carbolfuchsin staining techniques as well as fluorescent staining techniques. While carbolfuchsin staining techniques are less expensive and less time intensive, fluorescence staining techniques are currently the standard of care in many diagnostic laboratories. This is because AFB can be difficult to manually identify under a microscope after being stained using carbolfuchsin staining techniques.

### SUMMARY

The present disclosure relates to using an object detection model to screen for acid-fast bacteria (AFB) stained using a non-fluorescent staining technique. By using an object detection model for AFB screening, the sensitivity of the screening process, as well as its throughput may be improved. Furthermore, the embodiments disclosed herein allow diagnostic laboratories to use less expensive non-fluorescent staining techniques without sacrificing screening sensitivity. As a result, the embodiments disclosed herein improve the accuracy, efficiency, and cost of AFB screening in a diagnostic laboratory setting. Furthermore, embodiments disclosed herein may have increased utility in diagnostic laboratories that have less funding and/or fewer resources compared to other diagnostic laboratories, particularly those that cannot afford the equipment required to stain and detect AFB using fluorescent staining techniques.

In one embodiment, a method (that may be implemented at least in part using a computer) for assessing density of AFB in a smear involves obtaining a set of sample smear images stained using a non-fluorescent staining process, wherein the set of sample smear images captures at least a portion of the sample smear. The method further involves using the set of sample smear images as input to an object detection model configured to assess an AFB density measurement based on the sample smear image set input. The object detection model may be trained using a machine learning process in which training data comprises a plurality of sets of training smear images. The method further includes obtaining an AFB density measurement output based on output of the object detection model. Some embodiments comprise an initial step of staining sample smears using a non-fluorescent staining technique to obtain the sample smear images.

In some embodiments, the set of sample smear images may be captured by an imaging device such as a whole slide scanner and/or a microscope comprising a camera.

In some embodiments, the computer implemented method further involves generating a report and providing the report to one or more relevant entities wherein the one or more relevant entities comprises a laboratory professional, the patient, or a clinical provider for the patient.

The embodiments disclosed herein may be incorporated into a computer system. The computer system comprises one or more processors and one or more hardware storage devices comprising computer-executable instructions stored thereon that are executable by the one or more processors to cause the computer system to at least receive an input comprising a set of sample smear images, use the set of sample smear images an input to an object detection model wherein the object detection model is configured to assign an AFB density measurement based on the smear image set input, and obtain a density measurement output based on the output of the object detection model. The computer system can be part of a detection system that further comprises an imaging device (e.g., a whole slide scanner and/or a microscope comprising a camera) communicatively connected to the computer system and from which the set of sample smear images are received.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the disclosure will become apparent and more readily appreciated from the following description, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates an example computer system that may comprise or implement one or more embodiments of the present disclosure;

FIG. 2 illustrates an example flow diagram depicting acts associated with assessment of AFB density using an object detection model;

FIG. 3A through 3E illustrate example sample smear images and object detection outputs associated with assessment of AFB density in a sample smear;

FIG. 4 illustrates example components of a report summarizing findings related to assessment of AFB density and associated clinical actions.

### DETAILED DESCRIPTION

### Introduction

Before describing various embodiments of the present disclosure in detail, it is to be understood that this disclosure is not limited to the parameters of the particular example systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, any headings used herein are for organizational purposes only, and the terminology used herein is for the purpose of describing the embodiments. Neither are meant to be used to limit the scope of the description or the claims.

Embodiments of the present disclosure are directed to systems and methods for facilitating screening of AFB density using images comprising representations of a sample smear stained using a non-fluorescent staining process.

As used herein, the term “physician” generally refers to a medical doctor, or a specialized medical doctor, such as a radiologist, primary care physician, neurologist, or other medical doctor. This term may include any other medical professional, practitioner, or clinician, including any licensed medical professional or other healthcare practitioners, such as a physician's assistant, a nurse, a veterinarian (such as, for example, when the patient is a non-human animal), etc.

As used herein, the term “patient” generally refers to any human or animal, for example a mammal, under the care of a physician, as that term is defined herein, with typical reference to humans who have provided a diagnostic laboratory with a sample (e.g., a sputum sample) for detection of AFB therein. Such humans may include research participants, individuals under the care of a medical professional, and/or others. For purposes of the present application, a “patient” may be interchangeable with an “individual” or “person.” In some embodiments, the individual is a human patient.

As used herein, the term “laboratory professional” generally refers to an employee of a diagnostic laboratory responsible for organizing, testing, reporting, and/or otherwise facilitating the testing of clinical laboratory samples received from a patient or a physician of a patient.

### Example Systems and Methods for Assessment of Acid-Fast Bacteria Density

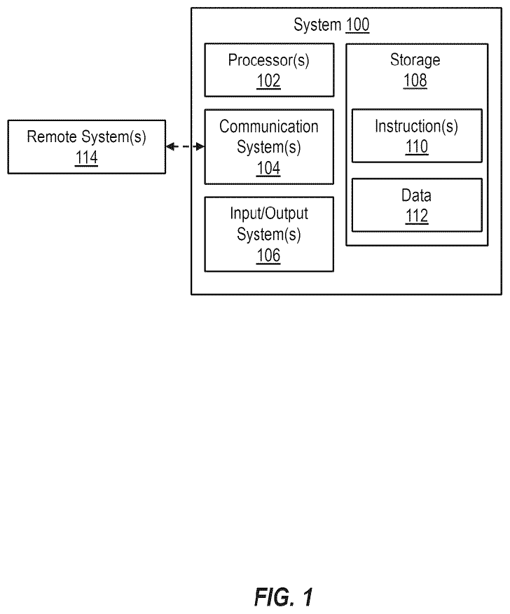

FIG. 1 illustrates an example computer system that may comprise or implement one or more embodiments of the present disclosure. As is illustrated in FIG. 1, the computer system 100 includes processor(s) 102, communication system(s) 104, I/O system(s) 106, and storage 108. Although FIG. 1 illustrates the computer system 100 as including particular components, it will be appreciated, in view of the present disclosure, that a computer system 100 may comprise any number of additional or alternative components.

The processor(s) 102 may comprise one or more sets of electronic circuitry that include any number of logic units, registers, and/or control units to facilitate the execution of computer-readable instructions (e.g., instructions that form a computer program). Such computer-readable instructions may be stored within storage 108. The storage 108 may comprise physical system memory or computer-readable recording media and may be volatile, non-volatile, or some combination thereof. Furthermore, storage 108 may comprise local storage, remote storage, or some combination thereof. Additional details related to processors (e.g., processor(s) 102) and computer storage media (e.g., storage 108) will be provided hereinafter.

As used herein, processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, random forest models, neural Turing machines, and/or others.

As will be described in more detail, the processor(s) 102 may be configured to execute instructions 110 stored within storage 108 to perform certain actions associated with assessing the density of AFB in a smear sample. The actions may rely at least in part on data 112 stored on storage 108 in a volatile or non-volatile manner (e.g., one or more sets of smear images). In some instances, the actions may rely at least in part on communication system(s) 104 for receiving data from remote system(s) 114, which may include, for example, other computer systems or computing devices, medical imaging devices/systems, and/or others.

The communications system(s) 104 may comprise any combination of software or hardware components that are operable to facilitate communication between on-system components/devices and/or with off-system components/devices. For example, the communications system(s) 104 may comprise ports, buses, or other physical connection apparatuses for communicating with other devices/components (e.g., USB port, SD card reader, and/or other apparatus). Additionally, or alternatively, the communications system(s) 104 may comprise systems/components operable to communicate wirelessly with external systems and/or devices through any suitable communication channel(s), such as, by way of non-limiting example, Bluetooth, ultra-wideband, WLAN, infrared communication, and/or others.

Furthermore, in some instances, the actions that are executable by the processor(s) 102 may rely at least in part on I/O system(s) 106 for receiving user input from one or more users. I/O system(s) 106 may include any type of input or output device such as, by way of non-limiting example, a touch screen, a display, a mouse, a keyboard, a controller, and/or others, without limitation.

In some embodiments, the computer system described hereinabove with reference to FIG. 1 is configured to assess the density of AFB in a smear of a patient. The computer system may comprise one or more processers and one or more hardware storage devices. As described with reference to FIG. 1, the one or more processers are configured to execute instructions stored within the one or more hardware storage devices. The instructions may cause the computer system to at least receive an input comprising a set of sample smear images, use the sample smear image set input as input to an object detection model, wherein the object detection model is configured to assign an AFB density measurement based on the smear image set input, and obtain a density measurement output based on the output of the object detection model.

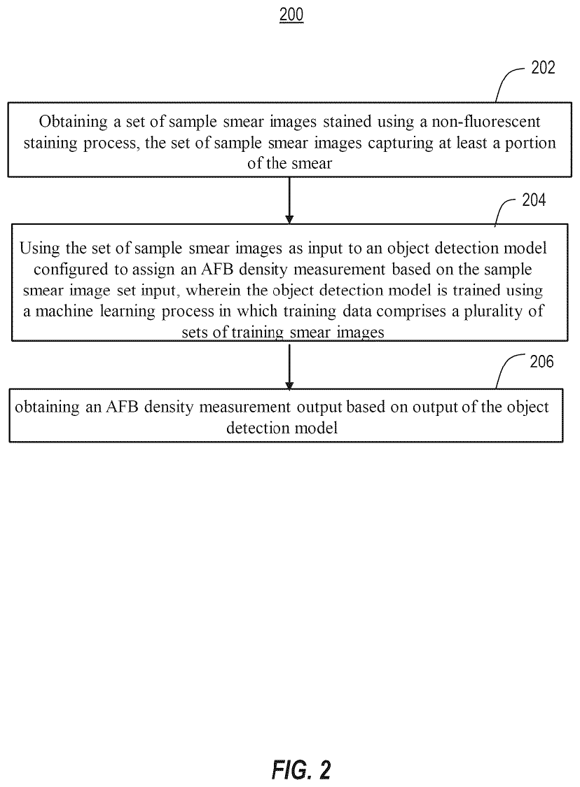

Some embodiments of the present disclosure can also be described in terms of acts (e.g., acts of a method) for accomplishing a particular result. Along these lines, FIG. 2 illustrates an example flow diagram 200, depicting acts associated with facilitating screening for AFB in a sample smear taken from a patient. Although the acts shown in flow diagram 200 may be illustrated and/or discussed in a certain order, no particular ordering is required unless specifically stated or required because an act is dependent on another act being completed prior to the act being performed. Furthermore, it should be noted that, in some implementations, not all acts represented in flow diagrams 200 are essential for facilitating screening for AFB.

In some instances, the various acts disclosed herein are performed using a computer system 100. For instance, code for configuring the computer system 100 to perform the various acts disclosed herein may be stored as instructions 110 on storage 108, and such instructions 110 may be executable by the processor(s) 102 (and/or other components) to facilitate carrying out of the various acts.

Act 202 of flow diagram 200 includes obtaining a set of sample smear images stained using a non-fluorescent staining process, wherein the set of sample smear images captures at least a portion of a sample smear. A sample smear is referred to herein as a smear used to detect AFB infection in a patient (e.g., a patient currently being treated/tested for AFB infection and/or awaiting a related diagnosis). In some instances, the sample smear is a sputum smear collected from a patient, wherein the sputum smear is stained using a non-fluorescent staining process (i.e., an acid-fast stain). For example, the sample smear may be stained using a carbolfuchsin staining process. In some instances, the carbolfuchsin staining process may comprise a Kinyoun staining process, a Ziehl-Neelsen staining process, and/or others.

The set of sample smear images may comprise a whole slide scan of the smear, wherein the whole slide scan captures the entirety of the sample smear. The whole slide scan may be captured with a whole slide scanner. In some embodiments, the set of sample smear images may comprise a plurality of microscope fields, wherein the plurality of microscope fields capture at least a portion of the sample smear (where typically each microscope field is a subset of the full whole slide). The plurality of microscope fields may be captured with a microscope comprising a camera. Such embodiments represent a less expensive alternative. Accordingly, these embodiments may be advantageous in settings that lack resources to obtain a full slide scanner. In some embodiments, the set of sample smear images may comprise a whole slide scan as well as one or more microscope fields. In some such instances, the whole slide scan may be partitioned into a plurality of fields (i.e., partitions the size of a typical microscope field) by the object detection model.

Act 204 of flow diagram 200 includes using the set of sample smear images as an input to an object detection model configured to assign an AFB density measurement based on the set of sample smear images. The AFB density measurement may be used by a physician as an initial diagnosis that can be used to inform future testing, treatment planning, and/or determination of the severity/progression of an AFB infection. For example, the AFB density measurement may comprise a density measurement in accordance with CLSI M48, wherein density measurements may comprise an AFB density score of +0, +1, +2, and +3. These AFB density scores taken in accordance with CLSI M48 represent a qualitative indication of AFB infection in a patient. An AFB density score of +0 indicates a very low concentration of AFB in a smear, wherein only a few representations AFB are observed in the set of sample smear images. A score of +0 may be indicative of early or paucibacillary cases of tuberculosis, or no AFB infection in a patient. An AFB density score of +1 indicates a slightly higher AFB load, wherein 1-10 representations of AFB are observed in each field. A score of +1 may be indicative of early or limited AFB infections. An AFB density score of +2 indicates a moderate AFB load, wherein 10-100 representations of AFB are observed in each field. A score of +2 may be indicative of an active AFB infection, wherein the active AFB infection may result in tuberculosis. An AFB density score of +3 indicates a high AFB load, wherein 100 or more representations of AFB are observed in each field. A score of +3 may be indicative of an advanced AFB infection, which could, for example, result in a severe case of tuberculosis.

The object detection model can be configured to obtain the AFB density measurement as described above. One will appreciate, in view of the present disclosure, that the object detection model may take on any suitable form and can include any suitable components for determining quantitative output based on the sample smear image set input, such as, by way of non-limiting example, an R-CNN model, a YOLO model, an FCOS model, a ResNet model, an SSD model, a DTER model, combinations thereof, and/or others. One will appreciate, in view of the present disclosure, that the object detection model(s) for determining the AFB density measurement in accordance with act 204 can include one or more additional pre-processing modules or post-processing modules.

In some embodiments, the object detection model(s) is/are configured/trained to identify representations of AFB in the sample smear image set input. Accordingly, the representations identified in the sample smear images may provide a basis for determining a density measurement associated with the sample smear represented in the sample smear image set input.

In accordance with act 204, the object detection model(s) may be trained using a machine learning process, in which training data comprises a plurality of sets of training smear images. The training data may further comprise ground truth output, which may comprise tags indicating representations of AFB in each set of training smear images and/or a respective AFB density measurement for the set of training smear images. Tagging may be performed by an expert, wherein experts manually identify and tag representations of AFB in each set of training smear images. Furthermore, experts may assign an AFB density measurement for each set of training smear images. In each set of training smear images, where one or more representations of AFB are identified, the object detection model(s) may be configured to determine automated AFB density measurements associated with the set of training smear images. Training smear images, as described herein, may comprise smear images that capture at least a portion of a smear associated with a former patient, (i.e., a patient that is no longer being actively monitored/treated for AFB infection).

In some embodiments, each set of training smear images includes additional clinical test results related to AFB infection, wherein the additional clinical test results corroborate the identification of representations of AFB in a respective set of training smear images. The additional clinical test may comprise one or more of nucleic acid amplification tests, susceptibility tests, AFB culture, and/or others. The additional clinical test results may be used to add weight to training data within a respective set of training smear images.

In some embodiments, in accordance with act 204, the object detection model is configured to spectrally deconvolute different stains used to stain a sample smear. For example, where a Kinyoun staining process is used to stain the sample smear, the object detection model may be trained to spectrally deconvolute carbolfuchsin stain and methylene blue stain. In such embodiments, the object detection model uses the deconvoluted carbolfuchsin stain and methylene blue stain to simulate different stain concentrations in the set of sample smear images. Such embodiments can improve the sensitivity of the object detection model by further distinguishing AFB representations in the set of sample smear images from background artifacts, improving identification of representations of AFB that overlap with other representations of AFB, background artifacts, and/or other structures in the set of sample smear images. Accordingly, in such embodiments, the object detection model is trained using training data related to spectral deconvolution of relevant stains (i.e., carbolfuchsin and methylene blue).

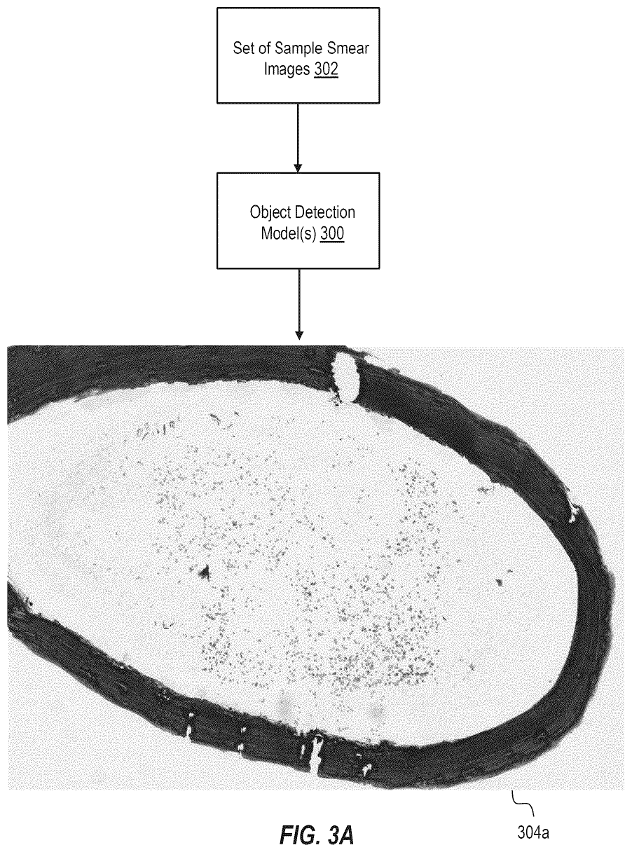

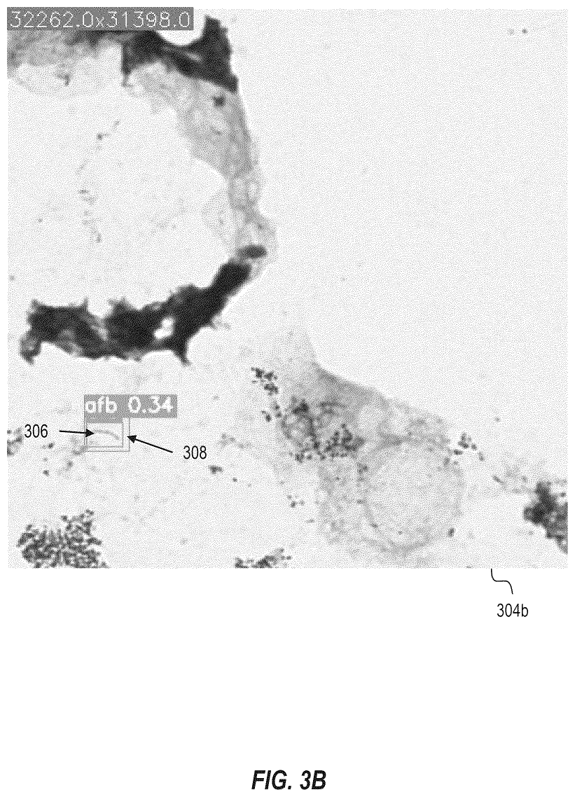

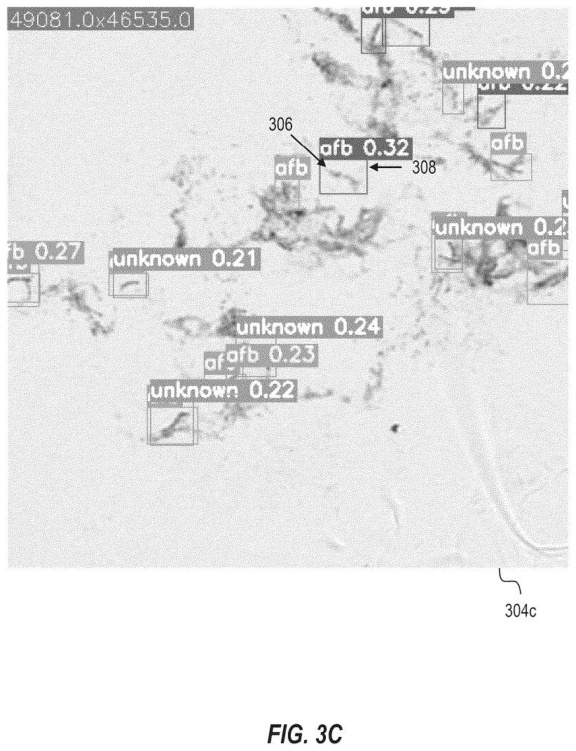

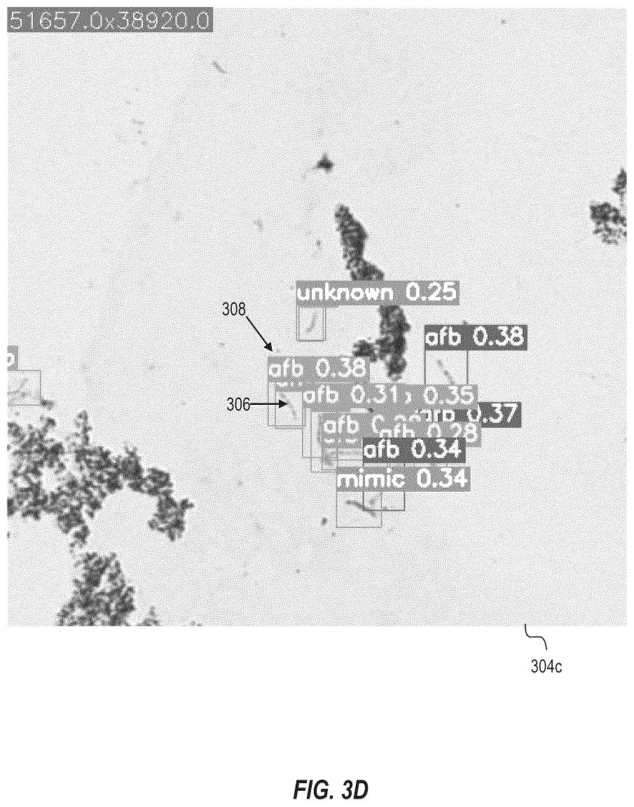

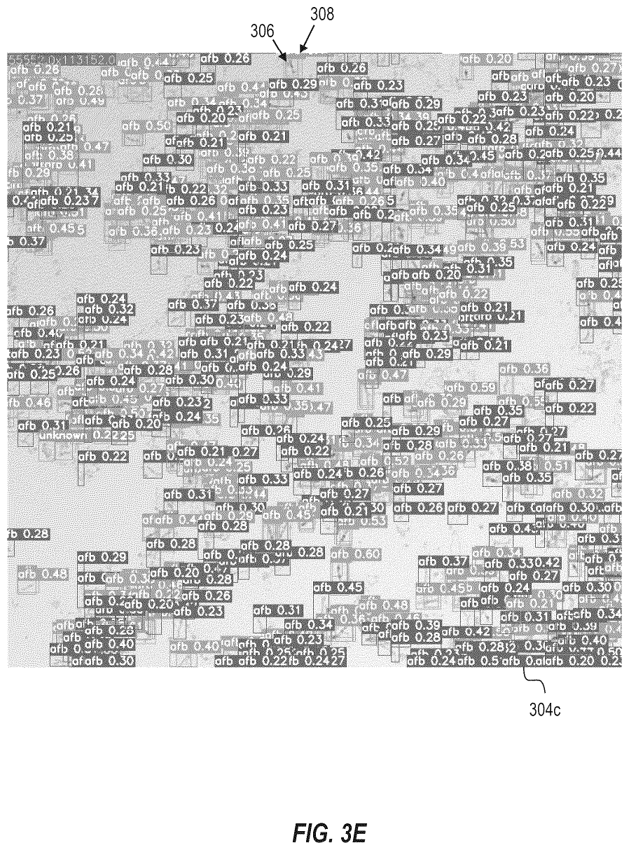

FIG. 3A illustrates a set of sample smear images 302 being provided as input to object detection model(s) 300. The set of sample smear images 302 may correspond to the set of sample smear images discussed hereinabove with reference to acts 202 and 204 of flow diagram 200. Similarly, the object detection model(s) 300 may correspond to the object detection model(s) discussed hereinabove with reference to act 204 of flow diagram 200. The object detection model(s) 300 can be configured to identify representations of AFB in the set of sample smear images. For example, the object detection model(s) 300 can tag representations of AFB. Sample smear image 304a represents whole slide scan wherein the object detection model(s) 300 have identified and tagged representations of AFB. The tagged representations of AFB may be used to calculate an AFB density in accordance with act 204 of flow diagram 200.

FIG. 3B illustrates a sample smear image 304b representing a field taken from a sample smear, wherein sample smear image 304b contains a representation of AFB 306. Each representation of AFB 306 identified in sample smear image 304b may be tagged and labeled with a respective bounding box 308. The representation(s) of AFB 306 are identified and tagged utilizing the object detection model(s) 300. The bounding box(es) 308 shown in sample smear image 304b can represent output or intermediate output of the object detection model(s) 300. The object detection model(s) 300 can be configured to produce an AFB density measurement associated with the number of representations of AFB 306 found in one or more sample smear images 304b and/or number of bounding boxes 308 produced by the object detection model(s) 300.

For instance, the object detection model may take an average of the number of representations of AFB 306 identified per field in the set of sample smear images 302 and assign an AFB density score to the sample smear represented in the set of sample smear images 302. This may be done by aggregating the number of representations of AFB identified in the set of sample smear images and dividing the number of representations of AFB by the number of fields in the set of sample smear images. As discussed hereinabove, such calculations may be obtained automatically utilizing the object detection model(s) 300. In other instances, the object detection model(s) 300 may provide AFB density data as input to a post processing module, the post processing module configured to provide an AFB density measurement output for the set of sample smear images.

FIGS. 3C-3E illustrate further examples of sample smear images with varying densities of identified representations of AFB 306. As illustrated in FIGS. 3B-3E, the object detection model(s) 300 can differentiate, identify, and tag representations of AFB 306 that overlap with other representations of AFB 306, overlap with other stained structures in the sample smear image or other artifacts that at least partially obscure a representation of AFB 306. The ability to identify at least partially obscured representations of AFB 306 in a sample smear image contributes to the accuracy and throughput improvements accorded by the computer systems and methods described herein.

Act 206 of flow diagram 200 involves obtaining an AFB density measurement output based on the output of the object detection model. The density measurement output may comprise the set of sample smear images, wherein representations of AFB in the set of sample smear images have been identified and labeled with bounding boxes by the object detection model. The AFB density measurement output may alternatively or additionally include an AFB density score of +0, +1, +2, or +3, and/or the number of AFB representations identified per field in the set of sample smear images.

The output may further comprise providing a notification to one or more relevant entities. A relevant entity may comprise, for example, the patient, a legal guardian of the patient, a primary care or other physician of the patient, a laboratory professional and/or others. The notification may be configured to apprise the one or more relevant entities of the AFB density measurement output generated in accordance with flow diagram 200. The notification may thereby enable the one or more relevant entities to seek medical attention as appropriate and/or future testing and/or treatment of a suspected AFB infection. In some instances, the notification is provided to a laboratory professional, wherein the notification can flag the corresponding sample smear for manual review by the laboratory professional and/or direct the laboratory professional to order further testing (e.g., a nucleic acid amplification test, susceptibility test, an AFB culture, and/or others). For example, an AFB density measurement output with a density of +1, +2, or +3 may trigger a notification for manual review of that particular sample smear and/or a recommendation for further testing. After manual review, the laboratory professional may relay the notification, optionally including their findings from the manual review, to one or more other relevant entities. In some instances, such as when an AFB density measurement comprises a score of +0, a notification is not sent to the laboratory professional.

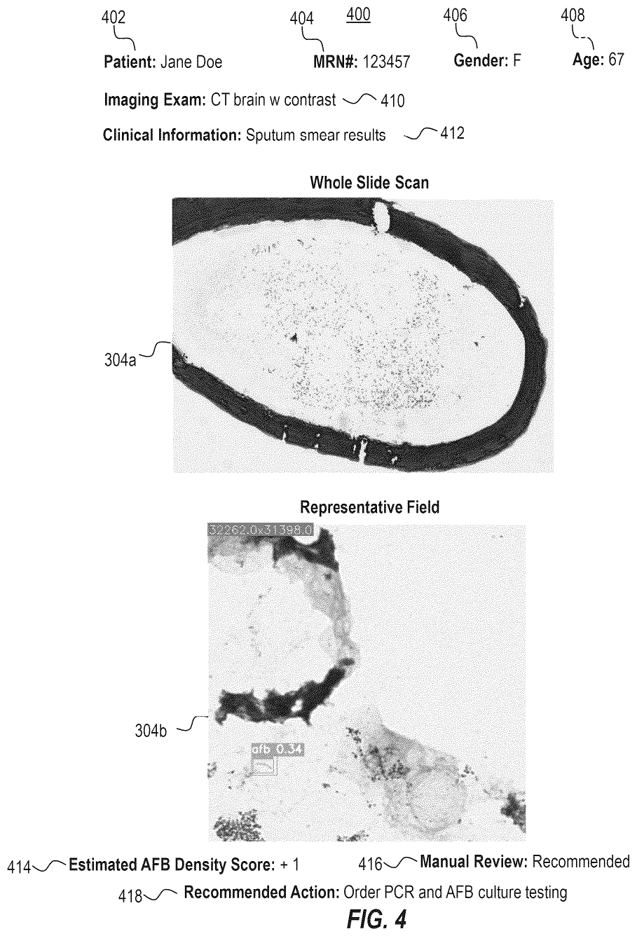

The notification provided to the relevant entity may take on various forms and/or may be provided in various ways. For example, in some embodiments, the notification takes the form of a report generated for viewing by the one or more relevant entities. In some instances, the report includes one or more representations of the sample smear including tagged representations of AFB (e.g., described below with reference to FIG. 4). Additionally, or alternatively, the report can include an AFB density measurement and/or the number of AFB representations identified per field in the set of sample smear images. Additionally, or alternatively, the report can suggest future testing and/or medical treatment based on the AFB density measurement. A report may comprise any additional or alternative graphics, charts, images, quantitative metrics, and/or information related to the patient.

In some instances, the reports from one or more sample smears may be entered into a digital patient tracking system. The patient tracking system could incorporate patient data from the output report as well as patient data from the EMR. The patient tracking system could provide a mechanism to follow up patient progress with referrals to clinical providers, including, for example, an ability to “snooze” a patient, putting their progress on hold temporarily but triggering follow up at a future time point.

In some instances, the information provided in the report may be added to or used to update the training data as described hereinabove with reference to act 204 of flow diagram 200.

By way of illustration, FIG. 4 illustrates example components of a report 400. Other reports may omit certain components and/or add other components. The example report 400 includes patient information, such as the patient's name 402 (this can be omitted for anonymity in certain implementations), medical record number 404, age 406, gender 408, type of AFB screening test 410 (“AFB sputum smear” in the example of FIG. 6), and/or clinical information 412 related to the patient and/or the AFB testing performed (“Sputum Smear Results” in the example of FIG. 4). In the example of FIG. 4, the report 400 includes one or more sample smear images (e.g., images 304a-304b). For instance, the report 400 may include a whole slide scan (image 304a in the example of FIG. 4) and/or one or more representative fields (image 304b in the example of FIG. 4). The report 400 may further comprise an AFB density measurement 414. The AFB density measurement 414 may be generated utilizing the object detection model(s), as discussed hereinabove with reference to act 204 of flow diagram 200. Furthermore, the report 400 may include a recommendation for manual review 416 and/or a recommended action 418.

### Additional Details Related to Implementing the Disclosed Embodiments

The principles disclosed herein may be implemented in various formats. For example, the various techniques discussed herein may be performed as a method that includes various acts for achieving particular results or benefits. In some instances, the techniques discussed herein are represented in computer-executable instructions that may be stored on one or more hardware storage devices. The computer-executable instructions may be executable by one or more processors to carry out (or to configure a system to carry out) the disclosed techniques. In some embodiments, a system may be configured to send the computer-executable instructions to a remote device to configure the remote device for carrying out the disclosed techniques.

Disclosed embodiments may comprise or utilize a special purpose or general-purpose computer including computer hardware, as discussed hereinabove. Disclosed embodiments also include physical and other computer-readable media for carrying or storing computer-executable instructions and/or data structures. Such computer-readable media can be any available media that can be accessed by a general purpose or special purpose computer system.

Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media (e.g., hardware storage devices) and transmission computer-readable media.

Physical computer-readable storage media includes hardware storage devices such as RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

### ADDITIONAL TERMS & DEFINITIONS

Although the subject matter described herein is provided in language specific to structural features and/or methodological acts, it is to be understood that the subject matter defined in the appended claims is not necessarily limited to the described features or acts so described. Rather, the described features and acts are disclosed as example forms of implementing the claims.

Unless defined otherwise, all technical and scientific terms used herein have the same meaning as commonly understood by one of ordinary skill in the art to which the present disclosure pertains.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A computer implemented method for assessing density of acid-fast bacteria (AFB) in a smear, the computer implemented method comprising:
obtaining a set of sample smear images stained using a non-fluorescent staining process, the set of sample smear images capturing at least a portion of the sample smear;
using the set of sample smear images as input to an object detection model configured to assign an AFB density measurement based on the set of sample smear images, wherein the object detection model is trained using a machine learning process in which training data comprises a plurality of sets of training smear images; and
obtaining an AFB density measurement output based on output of the object detection model.

2. The computer implemented method of claim 1, wherein the object detection model comprises an R-CNN module, a YOLO module, an FCOS module, a ResNet module, an SSD module, and/or a DTER module.

3. The computer implemented method of claim 1, wherein the object detection model is configured to:
identify one or more representations of AFB in the set of sample smear images;
process the set of sample smear images to determine the number of representations of AFB in the set of sample smear images; and
use the number of representations of AFB to determine an AFB density measurement for the set of sample smear images.

4. The computer implemented method of claim 3, wherein identifying one or more representations of AFB in the set of sample smear images includes labeling representations of AFB with bounding boxes.

5. The computer implemented method of claim 1, wherein each set of the plurality of sets of training smear images includes a representation of AFB in the set of training smear images and a respective AFB density measurement for the set of training smear images.

6. The computer implemented method of claim 5, wherein each set of training smear images includes additional clinical test results related to AFB infection.

7. The computer implemented method of claim 6, wherein the additional clinical tests comprise one or more of a nucleic acid amplification test, susceptibility test, and/or AFB culture.

8. The computer implemented method of claim 1, wherein the set of sample smear images comprises a plurality of microscope fields capturing at least a portion of the smear.

9. The computer implemented method of claim 1, wherein the set of sample smear images comprises a whole slide image.

10. The computer implemented method of claim 1, wherein the AFB density measurement comprises a score of 0+, 1+, 2+, 3+, or 4+.

11. The computer implemented method of claim 12, wherein slides that receive a score of 1+, 2+, 3+, or 4+ are flagged for manual review.

12. The computer implemented method of claim 1, wherein the set of smear images captures at least a portion of a sputum smear.

13. The computer implemented method of claim 1, wherein the smear is stained using a carbolfuchsin staining process.

14. The computer implemented method of claim 13, wherein the carbolfuchsin staining process comprises a kinyoun staining process.

15. The computer implemented method of claim 14, wherein the object detection model is configured to deconvolute carbol fuchsin stain and methylene blue stain in the set of smear images.

16. The computer implemented method of claim 15, wherein the object detection model uses the deconvoluted carbon fuchsin stain and methylene blue stain to simulate different stain concentrations in the set of smear images.

17. The computer implemented method of claim 1, implemented by a detection system that comprises a computer system and an imaging device communicatively connected to the computer system, wherein the imaging device comprises a whole slide scanner and/or a microscope that includes a camera.

18. The computer implemented method of claim 1, further comprising generating a report indicating the AFB density measurement of the set of sample smear images.

19. A computer system configured to assess the density of acid-fast bacteria (AFB) in a smear of a patient, the computer system comprising:
one or more processors; and
one or more hardware storage devices comprising computer-executable instructions stored thereon that are executable by the one or more processors to cause the computer system to at least:
receive an input comprising a set of sample smear images;
use the set of sample smear images as input to an object detection model, wherein the object detection model is configured to assign an AFB density measurement based on the smear image set input, wherein the object detection model is trained using a machine learning process in which training data comprises a plurality of sets of training smear images; and
obtain a density measurement output based on the output of the object detection model.

20. A detection system comprising:
an imaging device comprising a whole slide scanner and/or a microscope that includes a camera; and
the computer system of claim 19,
wherein the imaging device is communicatively connected to the computer system and wherein the computer system is configured to receive the set of sample smear images from the imaging device.
